(19) United States
(12) Patent Application Publication
(10) Pub. No.: US 2012/0132310 A1
(43) Pub. Date: May 31, 2012

(54) COMPOSITE TUBULAR PARTS WITH COMPLEX SHAPES

(75) Inventors: Frederick Cavaliere, Montigny Le Bretonneux (FR); Maurice Guitton, Nova Scotia (CA); Severine Guitton, Nova Scotia (CA); Claude Baril, Quebec (CA); Paul Bruhm, Nova Scotia (CA)

(73) Assignee: COMPOSITE ATLANTIC LIMITED, Nova Scotia (CA)

(21) Appl. No.: 13/148,482

(22) PCT Filed: Feb. 8, 2010
(86) PCT No.: PCT/EP10/51463

§ 371 Date: Feb. 8, 2012

(30) Foreign Application Priority Data
Feb. 10, 2009 (FR) 0950815

(51) Int. Cl. F16L 9/14

(52) U.S. Cl. 138/145

(57) ABSTRACT

A tubular part with a complex geometrical shape, the tubular part is made of a composite material including, on the one hand, a core part made of a very high-temperature resin obtained by a 3-D direct-creation method using a very high-temperature thermoplastic resin and, on the other hand, a coating of resin-impregnated fibres. The part includes, for example, at least one internal separation of the tube into several conduits that do not communicate with one another. The part is suitable for conveying air flows in opposite or separate directions. One of the conduits can be a dedicated cable raceway.

The present invention relates to the field of aeronautical parts. It relates more specifically to parts with a complex shape made of composites. Even more specifically, the application envisaged concerns tubular parts such as aeronautical pipes designed for the air circuit.

Piping parts for the air circuit are currently realized using a composite material in order to save mass. They are manufactured in pieces and then assembled. They are usually manufactured by laying up glass/phenolic resin fabrics on mandrel tools which are then removed.

These air piping parts are often very complex. Their external shape may possibly comprise branches, bends and it often has a variable cross-section. Moreover, the interior of these pipes may have one or more deflectors or separations.

Thus, these geometric constraints mean that many costly tools are required to realize these parts. Alternatively, they are realized in many segments that are subsequently assembled. In addition, these parts are subject to material constraints, since they must comply with fire, smoke, toxicity, etc. standards.

The objective of this invention is therefore to propose composite tubular parts having complex shapes, realized as a single element, allowing:
tools to be reduced and simplified (target: reducing one-off costs),
manufacturing and assembling parts to be simplified (target: reducing recurrent costs),
very complex shapes to be created allowing functions to be integrated that cannot be realized by conventional methods, while retaining reduced dimensional tolerances,
materials to be used that are best suited to compliance with the fire, smoke, toxicity standards.

To this end, the invention proposes a tubular part made of composite material comprising, firstly, a core part made of very high temperature resin obtained by a direct 3D creation method, and, secondly, a coating of fibers impregnated with resin.

It is understood that the tubular part is generally cylindrical in shape (possibly having a non-circular cross-section). In the application envisaged as an example this is an air duct.

In an advantageous embodiment, the tubular part has at least one internal separation of the tube into several ducts that do not communicate with one another.

In this case, the tubular part comprises for example a central duct and a set of at least two peripheral ducts surrounding this central duct.

With a view to a particular application, it thus comprises at least one duct designed for the passage of cables.

It is understood that the development of a method for realizing parts with arbitrarily complex shapes opens up the possibility of designing new air piping parts that could not be realized previously.

Amongst these, for instance, the integration into a single air pipe of two or more ducts receiving independent air or gas flows, possibly in opposite directions, can be envisaged.

According to various embodiments, possibly used together, the tubular part includes:
at least two bends oriented in different directions,
at least one branch,
at least one variation in cross-section along at least one of its segments,
at least one internal deflector possibly comprising bends,
at least one internal wall partially closing the tubular part locally,
at least one segment with a mainly square cross-section,
at least one segment with a mainly hexagonal cross-section,

According to an advantageous embodiment, the part comprises an anti-fire coating on at least one portion of its surface.

In an advantageous embodiment, the outer coating of resin-impregnated fibers is realized in the form of an interwoven braid.

Such a ‘sleeve’ made of tapes of impregnated fibers is created directly around the tubular part, or threaded onto it. This arrangement improves the tubular part's mechanical resistance.

Preferably, the part is obtained by a method comprising steps of:
creating a core part having a geometry substantially similar to the desired shape, except for the outer thickness, by a three-dimensional creation method,
wrapping at least one of this core part with fibers previously or subsequently impregnated with resin, in order to obtain the final dimensions of the desired shape after the resin has hardened,
and hardening of the resin.

It is understood that this is a method for producing a part with a complex geometric shape made of composite material having a structure reinforced by fibers.

Preferably, the three-dimensional creation method is a laser fusion method (SLS).

In the preferred embodiment, the thermoplastic resin used is a very high temperature thermoplastic resin.

More specifically, it is a PEEK (poly-ether-ether-ketone) type of very high temperature thermoplastic resin.

Alternatively, it is a PPS (for Poly-Phenylene Sulfone) type of thermoplastic resin.

It is understood that the invention combines known methods for realizing composite parts used in aeronautics and a laser fusion method, apparently not used in the aeronautics field since it produces parts unable to meet the constraints of use in an aeronautical environment with strict safety standards.

In the field of manufacturing complex-shaped parts, the use of laser fusion methods (laser sintering in English) is known; these are usually used to make prototype metal parts without tools from powders.

In a simplified way, an SLS (Selective Laser Sintering) type of laser fusion method, also sometimes called direct 3D printing, is a technique for selective laser sintering (heating and melting) without a liquid phase.

In this way objects are created with a three-dimensional geometry as complex as desired, layer by layer, formed as required on the lower layer, by using the energy of a laser to cause the local fusion of a powder (metal, nylon, polystyrene, etc.) at the selected location, corresponding to a future solid portion of the part desired.

The method is akin to rapid prototyping with the use of powders. As has been seen, the part is made from a powder bed by consolidating successive sections in an industrial machine.

The laser consolidates the layer at the surface of the preheated powder bed, the machine base penetrates to a predefined distance, a distribution system (usually a roller) deposits a new layer of powder, a new layer is consolidated by laser etc.

The final part obtained can have a very complex shape. No tooling (molding, machining etc.) is necessary to realize the part obtained by this laser fusion method.

The time to realize parts depends on the desired dimensions and quality of the part. It can take a relatively long time. However, several parts can be made at the same time, which makes the method interesting from a business point of view.

These methods are beginning to be used with composite powders. The laser fusion method is, for example, relatively well developed for polyamide (PA) types of powder.

The parts made of polyamide are usually intended to be rapid prototyping types of demonstration parts. Their lifespan is relatively short because of their limited mechanical performance.

Parts made of PEEK types of resin have also been realized by this method, and are intended in particular for made-to-measure parts for medical applications (e.g. cervical prostheses).

However, for reasons of material behavior and utilization temperatures, the PEEK resin (very high temperature thermoplastic powder) is more difficult to utilize than the polyamide resin.

The PEEK (poly-ether-ether-ketone polymer) thermoplastic resin has a melting temperature of 350° C., hence it is called a high temperature resin.

This fiber-reinforced thermoplastic resin has the following advantages: good mechanical properties, good fire resistance, good resistance to impact, low moisture absorption, rheological reversibility when heated to a sufficient temperature (in contrast to thermosetting resins, which have an irreversible behavior). All these properties make PEEK resin a suitable material increasingly used for aeronautical applications in the context of realizing parts made of composites.

In contrast, because of their method of realization, the parts obtained by a laser fusion method are generally not reinforced by fibers. Thus, in theory they have weak mechanical characteristics and, as a result, these parts are not naturally intended for the aeronautics market. It most often concerns prototype parts, not parts intended for actual use or mass production.

In addition various methods are known in the aeronautics field for realizing parts made of composites.

Among these methods can be cited, in particular:
the layup method of long fiber fabrics or tapes pre-impregnated with a thermosetting or thermoplastic resin,
the “RTM” (Resin Transfer Molding) method: realizing a fibrous preform with impregnation of thermosetting resin in a second step,

These methods require a polymerization (thermosetting resin) or consolidation (thermoplastic resin) operation under temperature, in a vacuum, and usually under pressure.

These methods are used to realize structural or non-structural parts.

The invention therefore proposes tubular parts having very complex shapes, obtained by combining a method from the medical field, choosing a work material suited to the constraints of the aeronautics field, with methods known in aeronautics.

According to a first embodiment, the core part is wrapped using a layup method for the core part using fabric or tapes pre-impregnated with resin.

Alternatively, the core part is wrapped using a resin transfer molding method.

For preference, in the step creating the core part, at least one portion of the surface of said core part intended to receive the fibers is roughened to boost mechanical binding with the fibers' impregnation resin.

This is especially advantageous in the case of a thermosetting resin.

The description that will follow, given solely as an example of an embodiment of the invention, is made with reference to the figures included in an appendix, in which:

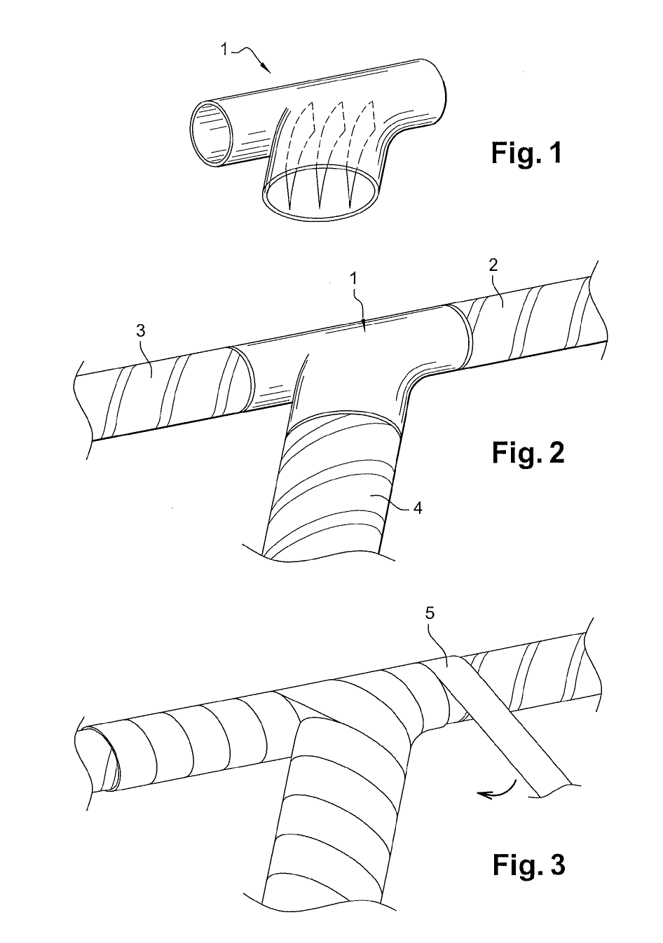

FIG. 1 illustrates a core part intended for an air duct, realized in a very high temperature thermosetting resin by laser fusion,

FIG. 2 shows the incorporation of this core part into a larger part comprising tools comprised, for example, of elements made of aluminum,

FIG. 3 illustrates the layup forming the complete part,

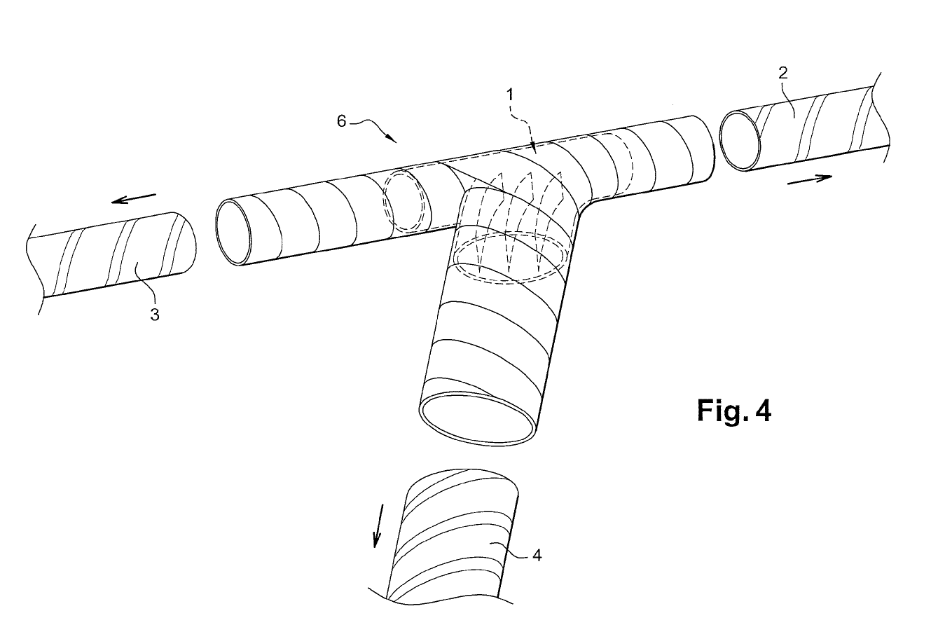

FIG. 4 illustrates the complete part in its final state after the tools have been extracted,

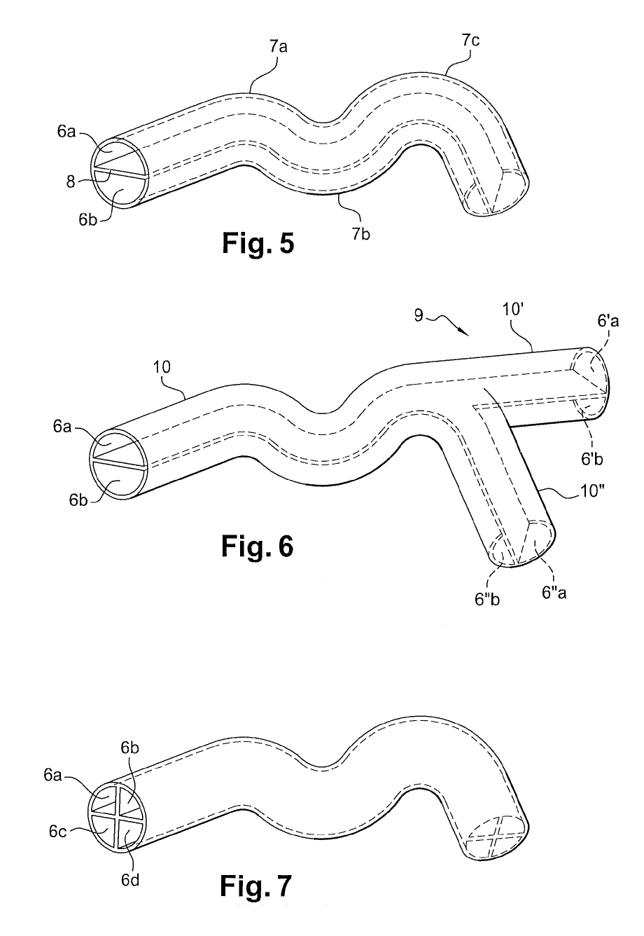

FIG. 5 illustrates a tube comprising several bends and an internal separation into two independent ducts,

FIG. 6 likewise illustrates a tube comprising a branch,

FIG. 7 likewise illustrates a tube divided into four independent ducts,

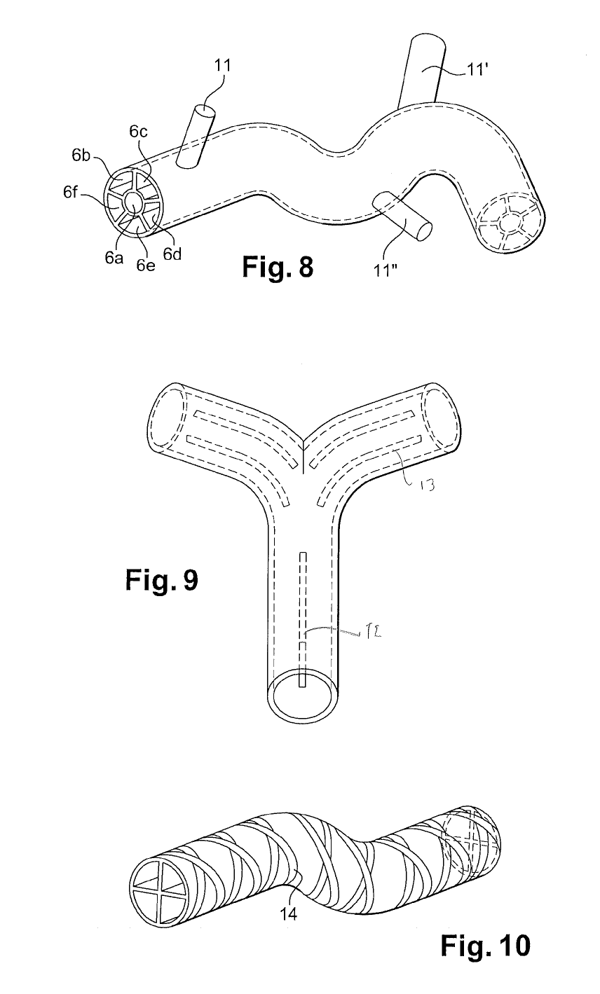

FIG. 8 illustrates a tube comprising six areas forming independent ducts, five of which circumferentially surround a sixth, along the tube's centerline; the tube also comprises three branches corresponding to some of the independent ducts,

FIG. 9 likewise illustrates a tube comprising longitudinal deflectors orienting the flow in a branch,

FIG. 10 illustrates a tube wrapped in a fiber-impregnated ‘sleeve’,

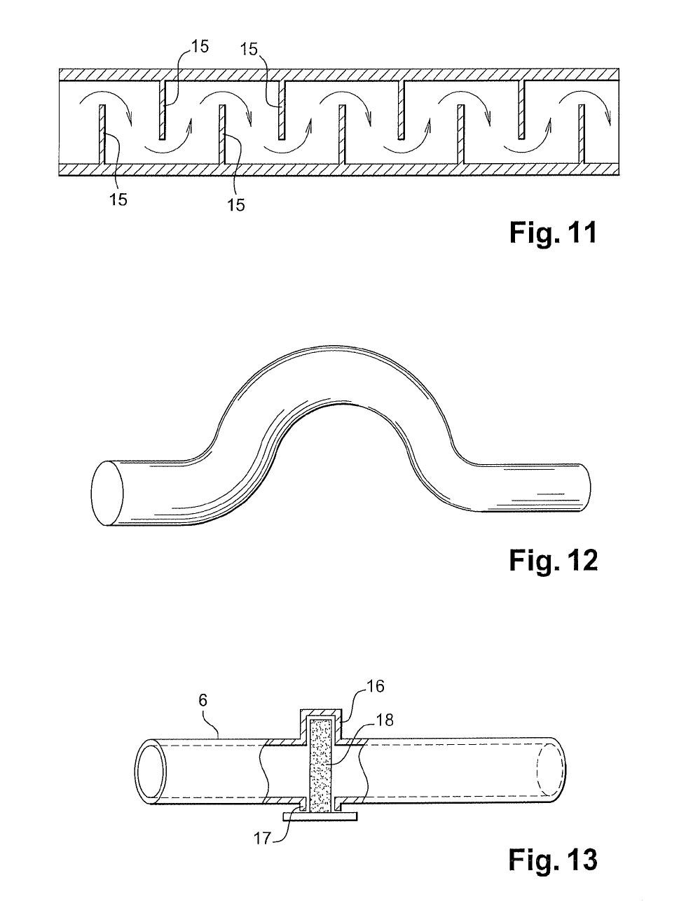

FIG. 11 illustrates a particular type of tube, forming an acoustic damper and comprising an alternating series of internal partitions partially closing the tube,

FIG. 12 illustrates a tube whose initial cross-section is clearly greater than its end cross-section,

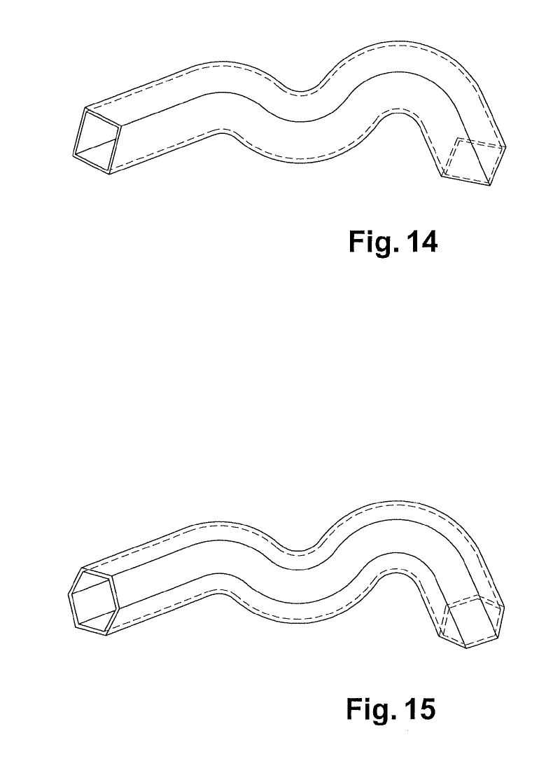

FIG. 13 illustrates a tube comprising a housing for an air filter,

FIG. 14 illustrates a tube with a square cross-section,

FIG. 15 illustrates a tube with a hexagonal cross-section.

A tubular part according to the invention comprises a core part realized in PEEK by a laser fusion method; this PEEK part is used as a base during the realization of a composite part by methods known per se of pre-impregnation or resin transfer molding (RTM).

In more detail, the method of manufacturing a tubular part according to the invention is implemented on the basis of specifications for a complete part to be realized. These specifications are obtained by conventional design methods, for example by using CAD software.

The method thus comprises a first step 100 of realizing a core part 1 using a laser fusion method (SLS), working on a very high temperature resin type of material, here a poly-ether-ether-ketone polymer (PEEK for short).

In practical terms, as will be understood from the described example of the invention, a ‘very high temperature resin’ should be understood to be a resin that firstly has physical and chemical characteristics that are stable at the temperatures to which parts made with such a resin may be subjected in operation and secondly, in the context of this invention, has sufficient stability at the temperatures to which the parts are temporarily subjected during their manufacturing process.

The design data for the core part 1 to be realized are obtained from the design data for the complete part, taking into account the future thickness of fibers impregnated with resin on a portion of the part's surface (and their possible variation during a curing phase). These data relative to the core part 1 to be realized are then integrated into software controlling the laser fusion device used.

The laser fusion method is assumed to be known per se and is therefore not described further herein. The dimensions of the core part to be realized are only limited by the characteristics of the laser fusion device.

Similarly, the PEEK material and its conditions of implementation are assumed to be known per se.

FIG. 1 shows the core part 1 once realized by a laser fusion method. This core part 1 here comprises a bent branch including three deflectors inside. It is clearly difficult to realize by conventional methods. It may in fact comprise multiple branches, internal separations into different ducts, variations in cross-section or thickness, without modifications to this step of the method.

The core part 1 is thus realized with internal dimensions according to the specifications of the final part to be realized, and external dimensions adapted by taking into account the future thickness of the impregnated fibers.

The surface of the PEEK core part is roughened, by known methods, to boost mechanical binding with the resin of the fabrics or tapes (especially in the case of thermosetting resins).

In a second step 105 of the method (FIG. 2), the core part 1 is assembled with tools 2, 3, 4, here of tubular type made of aluminum. These tools, which have a simple geometric shape, are realized by methods known per se. Their end cross-sections are naturally designed for correct assembly with the core part's end cross-sections. They also have external dimensions adapted to their future coating in impregnated fibers. The surface of these tools 2, 3, 4 is possibly treated with a view to being coated by impregnated fibers and then extracted.

The tools used may also consist of inflatable bladders, not shown in the drawing, made, for example, of a silicone material, a material widely used in the context of the polymerization of thermosetting resins. These bladders can then be removed after polymerization.

In a next step 110 (FIG. 3), the assembled intermediary part obtained at the end of the previous step is wrapped with fabrics or tapes 5 of fibers pre-impregnated with resin (thermosetting in this example), here by rolling around different segments of the part. It is noted that the layup concerns the core part 1 and the tools 2, 3, 4. The layup is realized by a technique known per se.

The thermosetting resin may be epoxy, phenolic or other resins that comply with fire, smoke, toxicity standards and have a polymerization temperature not exceeding 200° C. (to avoid approaching the PEEK resin's melting temperature).

It is noted that the walls of the PEEK part must be sealed to allow the layup of the fabrics or tapes (because of the constraints linked to polymerization in a vacuum).

In a variant, the layup method is replaced by an RTM, resin transfer molding, method. This involves realizing a dry fiber preform on the core part 1 made of very high temperature PEEK, and then impregnating it with resin in a sealed environment or tool provided for this purpose.

The resin transfer molding method (RTM, a method known per se) is characterized by the fact that layers of pre-cut dry fibers are placed in a mold, which is sealed, into which is injected a resin that will impregnate the fibers. In the case of fibers impregnated with thermosetting resin, the resin is then polymerized.

In both cases, in a next step 120, the complete part is finished by polymerization or consolidation of the resin, then the tools 2, 3, 4, made of metal or a flexible material, are extracted, here by pulling along their axes.

FIG. 4 then shows the final state of the complete part 6.

The advantage of combining the two methods makes it possible to benefit from the advantages of each method and minimize the inconveniences:

1/ the PEEK part is realized without tools.

2/ the PEEK part can have a complex shape with functions integrated, with a negligible impact on the production cost. It can be much longer (in one piece) than with known methods.

3/ laying up the fabrics is carried out on the PEEK part, which requires few or no tools. When tools are used, these are much simpler tools than those which would be needed to realize parts having complex shapes by the traditional techniques.

4/ the fabrics or tapes provide the reinforcement needed to obtain sufficient mechanical properties for the final part. The mechanical performance of the PEEK part must therefore solely permit the layup and/or impregnation operation, and then polymerization. This allows the design and realization of the PEEK part to be simplified. The polymerization temperature of the resins used does not exceed 200° C. This temperature level allows the PEEK part's geometry to be unchanged.

5/ the PEEK resin complies very well with fire, smoke, toxicity standards.

The method is particularly suitable for closed or revolving parts (e.g. tubular parts). In this case the fabrics or tapes are laid up around the PEEK part.

The use of the method paves the way for the realization of tubular parts, for example for the air circuit, that could not be envisaged previously.

Various types of specific parts that can be realized by the method as described are illustrated in FIGS. 5-15.

As can be seen in FIG. 5, the complete part 6 can take the shape of a cylindrical tube with several bends 7a, 7b, 7c (three on this non-limiting illustration). These bends 7a, 7b, 7c are, for example, designed to make it easier to attach the complete part 6 along an inner wall of an airplane fuselage, which itself has a complex shape because of the many structural elements and equipment installed in the aircraft.

The complete part 6 also has an internal separation 8, here arranged as a ruled surface whose generating line is a diameter of the cylindrical tube. Such a part thus has two internal ducts 6a, 6b, designed, for example, for the passage of air flows in opposite directions, or simply independent air flows.

FIG. 6 illustrates a tube similar to the one in FIG. 5, but also comprising a branching 9 of the main tube 10 into two secondary tubes 10′, 10″. In the case illustrated, the branch maintains the tube's separation into two ducts, and each secondary tube 10′, 10″ therefore also comprises two ducts (marked 6′a, 6′b and 6″a, 6″b, respectively). It is clear that the branch may very simply concern just one of the two ducts.

A variant of FIG. 5 is illustrated by FIG. 7, in which there is a bent cylindrical tube 6, here divided into four internal ducts 6a, 6b, 6c, 6d, by a cross-shaped separation.

Depending on the needs of the application in question, one of the internal ducts can receive a different surface treatment (e.g. fire-resistant paint) from the other ducts.

In an even more sophisticated variant of this concept, as illustrated in FIG. 8, the complete tubular part 6 comprises a central tubular duct 6a, generally cylindrical and concentric with the complete part 6, surrounded by 5 peripheral ducts 6b, 6c, 6d, 6e, 6f.

These peripheral ducts 6b, 6c, 6d, 6e, 6f here have substantially the same cross-section, which is delimited by an arc of the external wall of the complete part 6, an arc of the external wall of the central duct 6a, and radii of the complete part 6, distributed at equal angular intervals.

Here the complete part 6 also has branches 11, 11′, 11″, each of which involves a single peripheral duct. Clearly, these branches could also involve two or more internal ducts, depending on requirements.

In this configuration, the complete part 6 is typically designed to carry air flows (for example, intended for different areas of the airplane) in the peripheral ducts, and a set of cables in the central duct 6a.

As the air flows are independent here, transporting air flows with different temperatures intended for different areas of the airplane, for example, can be considered.

Likewise, this type of tube with multiple ducts allows the various air vents to be supplied separately. A simple tube makes it possible, in particular, to avoid having the air flow stronger immediately next to the air-conditioning device and weaker for the air vents that are farthest away from it.

Another type of part that can be realized by the method described is illustrated in FIG. 9. This tubular part 6 comprises a branch 9, with the two secondary tubes 10′, 10″ being bent. The main tube 10 here comprises two internal deflectors 12, 13 allowing the air flow to be oriented.

These deflectors 12, 13 are in the form of walls inside the tube, not necessarily over its entire width (or only over a pre-defined length of the tube). Thus the air flow is not necessarily separated into several independent volumes, but is better channeled so as to avoid turbulence.

As FIG. 9 shows, here these secondary deflectors are also arranged in the branches 10′, 10″ of tube 6.

In a variant embodiment of the external portion of the complete part, shown in FIG. 10, the core part 1, made of PEEK very high temperature resin and separated into four internal ducts by a cross-shaped separation, is surrounded by a fiber-impregnated “sleeve” 14. This “sleeve”, braided around the core part or threaded onto it, allows the final part 6 to have very good mechanical resistance. It typically comprises two layers of fibers wound in an interwoven spiral around the tubular part.

FIG. 11 shows a realization of a tubular part 6 comprising an internal sound damper, realized in the form of alternating internal dividers 15 perpendicular to the tube 6, creating a forced path for the air flow in the tube, according to a standard geometry.

Other geometries enabling noise damping can also be considered.

FIG. 12 shows a tube with multiple bends and a tapered cross-section, thus enabling an accelerated air flow on leaving the tube. Such a tube cannot be realized easily by conventional methods.

As shown in FIG. 13, the tube 6 can comprise a housing 16 and a surface opening 17, designed to receive an interchangeable air filter 18 of a type known per se.

Finally, FIGS. 14 and 15 illustrate the possibility of realizing tubes with a rectangular or polygonal (here, hexagonal) cross-section, according to the constraints of use and of the airplane's internal area intended to accommodate the part.

In the case of a rectangular cross-section, this method allows parts to be realized that have two thin walls and two thick walls, according to the mechanical or environmental constraints the part must comply with.

These geometries are naturally compatible with branches and separations, or internal deflectors, as explained above.

In another variation, the piece made of PEEK thermoplastic resin is not completely covered by impregnated-fiber tapes. It comprises, for example, studs forming projections designed to form brackets for fixing onto the aircraft's structure, or brackets for fixing other equipment or elements.

It is understood that using the method allows parts to be created that are as close as possible to the final application in the aircraft cabin.

In another variant, not shown, the tubular part 6 receives a surface treatment with fire-resistant paint. Other types of treatments are of course possible, depending on the needs of specific applications.

In a material variant, a PPS (Poly-Phenylene Sulfone) type of thermoplastic resin is used instead of the PEEK resin mentioned in the description, with no substantial change to the method.

In a variant embodiment, the tubular parts also comprise a layup on at least one portion of an inner surface, a layup making it possible, for example, to avoid abrasion that could cause premature wear of the PEEK part). In this configuration the PEEK part is comprised between two layups, one on the inner and the other on the outer surface.

1-9. (canceled)

10. Tubular part made of composite material comprising, firstly, a core part made of very high temperature resin, and, secondly, a coating of fibers impregnated with resin, characterized in that it comprises inside the tube, over at least a portion of its length, internal separators.

11. Tubular part according to claim 10, wherein it comprises at least one internal separation of the tube into several ducts (6a, 6b) that do not communicate with one another.

12. Tubular part according to claim 11, wherein it comprises at least one central duct and a set of at least two peripheral ducts surrounding this central duct.

13. Tubular part according to claim 10, wherein it comprises, possibly jointly,
at least two bends (7),
at least one branch (9),
at least one variation in cross-section along at least one of its segments,
at least one internal deflector (12) possibly comprising bends,
at least one internal wall (15) partially closing the tubular part locally,
at least one segment with a mainly square cross-section,
at least one segment with a mainly hexagonal cross-section.

14. Tubular part according to claim 10, wherein the very high temperature resin is a PEEK (poly-ether-ether-ketone) type of thermoplastic resin.

15. Tubular part according to claim 10, wherein the very high temperature resin is a PPS (Poly-Phenylene Sulfone) type of thermoplastic resin.

16. Tubular part according to claim 10, wherein the outer coating of resin-impregnated fibers (5) is realized in the form of an interwoven braid.

17. Tubular part according to claim 10, wherein comprises a surface treatment with fire-resistant paint.

18. Tubular part according to claim 10, wherein is realized by a method comprising steps of:
100—creating a core part (1) having a geometry substantially similar to the desired shape, except for the outer thickness, by a laser fusion type of three-dimensional creation method, said core part being realized in a very high temperature thermoplastic resin,
110—wrapping at least one portion of said core part (1) with fibers (5) previously or subsequently impregnated with resin, until the final dimensions of the desired shape are obtained,
120—hardening of the resin.
